(19) United States
(12) Patent Application Publication
(10) Pub. No.: US 2011/0306327 A1
(43) Pub. Date: Dec. 15, 2011

(54) Method for forwarding multimedia messages in a public land mobile network, the handling of a short message, Core Network for forwarding multimedia messages in a public land mobile network, and Unit providing a multimedia message forwarding function in a Core Network

(75) Inventors: Daniel Schandl, Judenau (AT); Florian Prikowitsch, Orth an der Donau (AT); Michael David Fuchshuber, Vienna (AT)

(73) Assignee: T-MOBILE AUSTRIA GMBH, Wien (AT)

(21) Appl. No.: 13/155,589

(22) Filed: Jun. 8, 2011

Related U.S. Application Data
(60) Provisional application No. 61/354,595, filed on Jun. 14, 2010.

(30) Foreign Application Priority Data
Jun. 14, 2010 (EP) 10 006 123.3

(51) Int. Cl. H04W 4/00

(52) U.S. Cl. 455/414.1

(57) ABSTRACT

A method for forwarding multimedia messages in a public land mobile network using a core network with a unit providing a multimedia message forwarding function, includes storing, in a forwarding information database, a multimedia message forwarding information related to forwarding, to a second international mobile subscriber identity, of multimedia messages directed to a first international mobile subscriber identity. The public land mobile network, receives a request for a delivery of a mobile terminated multimedia message to the first international mobile subscriber identity. The multimedia message forwarding function determines the multimedia message forwarding information. The multimedia message forwarding function forwards the multimedia message to the second international mobile subscriber identity based on the multimedia message forwarding information so that the forwarding is performed based on at least one of a time of reception of the multimedia message, a state of activation of a subscriber associated with the first international mobile subscriber identity and a state of activation of the subscriber associated with the second international mobile subscriber identity.

### CROSS REFERENCE TO RELATED APPLICATIONS

This application claims priority to U.S. Provisional Application Ser. No. 61/354,595, filed Jun. 14, 2010, and to European Patent Application No. EP 10 006 123.3 filed Jun. 14, 2010, which are hereby incorporated by reference herein in their entirety.

### FIELD

The present invention relates a method for forwarding multimedia messages in a public land mobile network. Furthermore, the present invention relates to a Core Network for forwarding multimedia messages in a public land mobile network, and to a Unit providing a multimedia message forwarding function in a Core Network.

### BACKGROUND

Call forwarding for voice calls is a standard functionality of Global System of Mobile Communication (GSM) and Universal Mobile Telecommunication System (UMTS) radio access networks. However, the forwarding of multimedia messages has hitherto not been possible in practice.

A forwarding functionality with respect to short messages is disclosed in international patent application publication WO 2008/006462 A1. However, this solution does not provide for a solution for forwarding multimedia messages.

### SUMMARY

In an embodiment, the present invention provides a method for forwarding multimedia messages in a public land mobile network using a core network with a unit providing a multimedia message forwarding function. A multimedia message forwarding information is stored in a forwarding information database, the multimedia message forwarding information being related to forwarding, to a second international mobile subscriber identity, of multimedia messages directed to a first international mobile subscriber identity. The public land mobile network, receives a request for a delivery of a mobile terminated multimedia message to the first international mobile subscriber identity. The multimedia message forwarding function determines the multimedia message forwarding information. The multimedia message forwarding function forwards the multimedia message to the second international mobile subscriber identity based on the multimedia message forwarding information so that the forwarding is performed based on at least one of a time of reception of the multimedia message, a state of activation of a subscriber associated with the first international mobile subscriber identity and a state of activation of the subscriber associated with the second international mobile subscriber identity.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 schematically illustrates a diagram of the inventive unit providing a multimedia message forwarding function according to an embodiment of the present invention; and

FIG. 2 schematically illustrates a part of a public land mobile network (PLMN) and especially a part of a Core Network of such a public land mobile network (PLMN) for executing the method according to an embodiment of the present invention and having a unit providing a multimedia message forwarding function according to the present invention.

### DETAILED DESCRIPTION

An aspect of the present invention is to provide a method for forwarding multimedia messages in a public land mobile network. A further aspect of the present invention is to provide a Core Network for forwarding multimedia messages in a public land mobile network, a unit providing a multimedia message forwarding function in a Core Network, a program comprising a computer readable program code for controlling a unit providing a multimedia message forwarding function, and a computer program product comprising a computer-readable storage medium having computer-readable program instructions embodied in the medium for executing the inventive method. One aspect of the present invention is to be able to easily and efficiently (especially cost efficiently) implement a forwarding functionality of multimedia messages in an existing public land mobile network (PLMN) or radio access network that previously did not have such an additional functionality.

In an embodiment, the present invention provides a method for forwarding multimedia messages in a public land mobile network (PLMN), the public land mobile network (PLMN) comprising a Core Network having a unit providing an multimedia message forwarding function for forwarding multimedia messages, the method comprising the steps of:
in a forwarding information database, storing a multimedia message forwarding information being related to the forwarding to a second International Mobile Subscriber Identity (IMSI) of multimedia messages that are directed to a first International Mobile Subscriber Identity (IMSI),
the public land mobile network (PLMN) receiving a request for the delivery of a mobile terminated multimedia message to the first International Mobile Subscriber Identity (IMSI),
the multimedia message forwarding function determining the multimedia message forwarding information, and
the multimedia message forwarding function providing for the forwarding of the multimedia message to the second International Mobile Subscriber Identity (IMSI).

According to an embodiment of the present invention, it is thereby advantageously possible that a complete reutilization of existing interfaces of all network elements can be realized that are involved in the handling of mobile terminated multimedia messages. Especially, this is true for the interfaces of the Multimedia Messaging Service Center (MMSC) and/or of the interfaces of the Wireless Application Part Gateway (WAP GW), but also the interfaces of the Short Message Service Center (SMSC), the Mobile Switching Center (MSC) and the Home Location Register (HLR) of the public land mobile network (PLMN) can be reused. It is advantageous according to an embodiment of the present invention that no modification of any existing network element is necessary due to the enhanced functionality because all the functionalities of the multimedia message service for a User Equipment connected to the public land mobile network (PLMN) resides within the unit providing the multimedia message forwarding function. Moreover, such an implementation provides a comparably high degree of flexibility, ease of implementation of the new functionality, and ease of administration of this additional functionality. It is advantageous according to an embodiment of the present invention that the inventive functionality can be implemented in different types of public land mobile networks (PLMN) such as GERAN (GSM Edge Radio Access Network) networks or UTRAN (UMTS Terrestrial Radio Access Network) networks.

Preferably, the unit providing the multimedia message forwarding function comprises three different functional blocks, namely an interaction functional block, a translation functional block and a charging functional block. Thereby, it is possible to keep the interactions comparably simple.

According to an embodiment of the present invention, it is furthermore preferred that the multimedia message forwarding information is provided such that the forwarding to the second International Mobile Subscriber Identity (IMSI) of the multimedia message directed to the first International Mobile Subscriber Identity (IMSI) depends on at least one parameter out of the time of reception of the multimedia message, the state of activation of the subscriber related to the first International Mobile Subscriber Identity (IMSI), and the state of activation of the subscriber related to the second International Mobile Subscriber Identity (IMSI).

According to an embodiment of the present invention, it is advantageous that a very flexible forwarding pattern is easily possible to be implemented by means of the inventive method.

According to an embodiment of the present invention, the present invention provides a method for forwarding multimedia messages in a public land mobile network (PLMN), the public land mobile network (PLMN) comprising a Core Network having a unit providing an multimedia message forwarding function for forwarding multimedia messages, the method comprising the steps of:
in a forwarding information database storing a multimedia message forwarding information being related to the forwarding to a second International Mobile Subscriber Identity (IMSI) of multimedia messages that are directed to a first International Mobile Subscriber Identity (IMSI),
the public land mobile network (PLMN) receiving a request for the delivery of a mobile terminated multimedia message to the first International Mobile Subscriber Identity (IMSI),
the multimedia message forwarding function determining the multimedia message forwarding information, and
the multimedia message forwarding function providing for the forwarding of the multimedia message to the second International Mobile Subscriber Identity (IMSI), wherein the multimedia message forwarding information is provided such that the forwarding to the second International Mobile Subscriber Identity (IMSI) of the multimedia message directed to the first International Mobile Subscriber Identity (IMSI) depends on at least one parameter out of the time of reception of the multimedia message, the state of activation of the subscriber related to the first International Mobile Subscriber Identity (IMSI), and the state of activation of the subscriber related to the second International Mobile Subscriber Identity (IMSI).

According to the above mentioned embodiment of the present invention, it is preferred that the multimedia message forwarding information is provided such that the forwarding to the second International Mobile Subscriber Identity of the multimedia message directed to the first International Mobile Subscriber Identity depends on
a location information of the subscriber related to the first International Mobile Subscriber Identity and/or on
a location information of the subscriber related to the second International Mobile Subscriber Identity.

Thereby, it is advantageously possible to provide a most flexible and convenient forwarding functionality of the multimedia message. It is evident, that the information about the location of the subscriber related to the first International Mobile Subscriber Identity and/or the information about the location of the subscriber related to the second International Mobile Subscriber Identity is to be detected or is to be made available to the multimedia message forwarding function.

Furthermore, it is preferred according to an embodiment of the present invention that the multimedia message forwarding function provides for the initialization and/or the definition of a charging for the forwarding of the multimedia message.

The advantage associated with such an embodiment is that a dedicated charging associated to the forwarding functionality according to the embodiment of the present invention can be easily realized.

According to an embodiment of the present invention, it is furthermore preferred that the multimedia message forwarding information is defined by means of at least one out of an Unstructured Supplementary Service Data (USSD) message, an internet user interface, and a Dual Tone Multiple Frequency (DTMF) menu.

Thereby, it is advantageously possible to easily and effectively modify and configure the forwarding functionality of the present invention.

In an embodiment, the present invention, provides a Core Network for forwarding multimedia messages in a public land mobile network (PLMN), the Core Network comprising at least one of a Multimedia Messaging Service Center (MMSC) and a Wireless Application Part Gateway (WAP GW), and the Core Network further comprising a unit providing a multimedia message forwarding function for forwarding multimedia messages, wherein the multimedia message forwarding function provides a forwarding to a second International Mobile Subscriber Identity (IMSI) of a multimedia message directed to a first International Mobile Subscriber Identity (IMSI) dependent on a multimedia message forwarding information stored in a subscriber database.

It is especially preferred according to an embodiment of the present invention that the multimedia message forwarding information is provided such that the forwarding to the second International Mobile Subscriber Identity (IMSI) of the multimedia message directed to the first International Mobile Subscriber Identity (IMSI) depends on at least one parameter out of the time of reception of the multimedia message, the state of activation of the subscriber related to the first International Mobile Subscriber Identity (IMSI), and the state of activation of the subscriber related to the second International Mobile Subscriber Identity (IMSI).

According to an embodiment of the present invention, it is thereby advantageously possible that a very flexible and efficient forwarding functionality can be implemented.

A unit provides a multimedia message forwarding function in a Core Network according to an embodiment of the present invention, wherein the multimedia message forwarding function provides a forwarding to a second International Mobile Subscriber Identity (IMSI) of a multimedia message directed to a first International Mobile Subscriber Identity (IMSI) dependent on a multimedia message forwarding information stored in the forwarding information database.

A program comprises a computer readable program code for controlling an unit providing a multimedia message forwarding function according to an embodiment of the present invention.

A computer program product comprises a computer-readable storage medium having computer-readable program instructions embodied in the medium for executing the method according to an embodiment of the present invention. Or for controlling an Core Network according to an embodiment of the present invention.

By means of a complete reutilisation of existing interfaces, especially interfaces of the Multimedia Messaging Service Center (MMSC) or the Wireless Application Part Gateway (WAP GW) according to the present invention, no modification of any existing network element is necessary.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

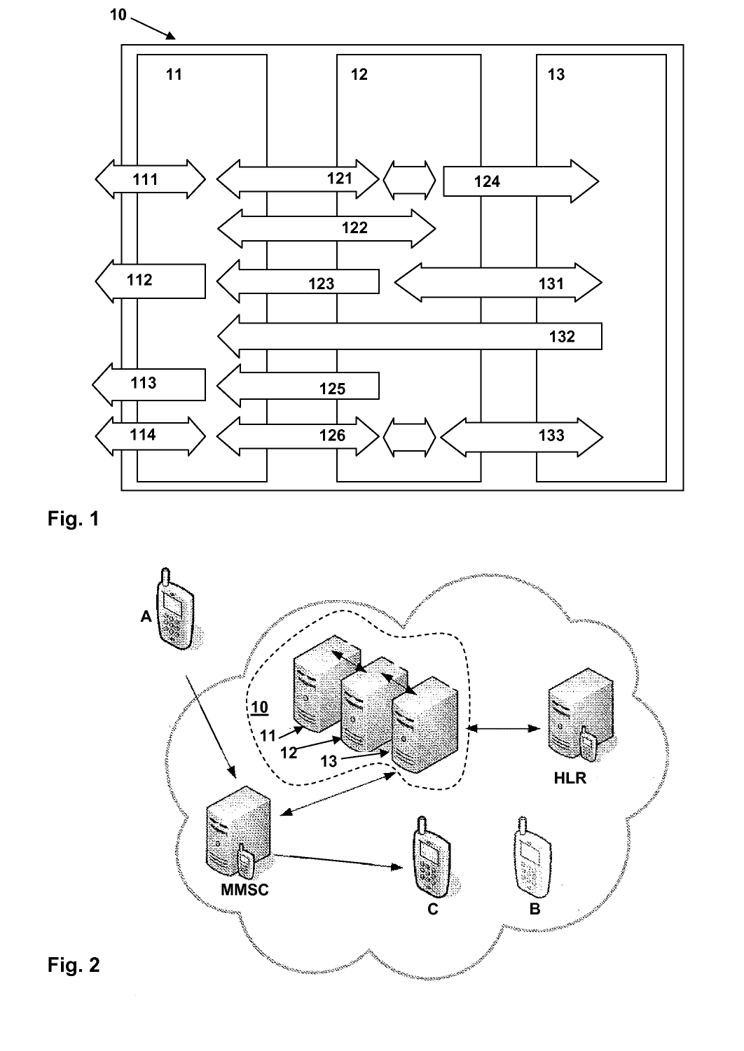

In FIG. 1, a diagram of the inventive unit 10 providing a multimedia message forwarding function according to an embodiment of the present invention is schematically shown. The unit 10 providing a multimedia message forwarding function is preferably part of a Core Network.

In FIG. 2, a part of a public land mobile network (PLMN) and especially a part of a Core Network 20 of such a public land mobile network (PLMN) for executing the method according to an embodiment of the present invention is schematically shown. The Core Network 20 comprises unit 10 providing a multimedia message forwarding function according to the present invention.

The unit 10 providing a multimedia message forwarding function preferably comprises an interaction functional block 11, a translation functional block 12 and a charging functional block 13.

The interaction functional block 11 comprises the interface mapping, i.e. the mapping of different protocols used in the communications with various network entities such as a Multimedia Messaging Service Center (MMSC), a Short Message Service Center (SMSC), a Mobile Switching Center (MSC), and/or a subscriber database (e.g. a Home Location Register (HLR)). The interaction functional block 11 is used for detecting the originating and terminating subscriber address information (i.e. the International Mobile Subscriber Identity (IMSI) of the initiating subscriber A (originating subscriber address) and the International Mobile Subscriber Identity (IMSI) of the first subscriber B (terminating subscriber address)). Furthermore, the interaction functional block 11 is also used for influencing of and communicating with the translation functional block 12 as well as the charging functional block 13. The translation functional block 12 comprises the service logic and preferably a database comprising the forwarding information (in the context of the present invention, such a database is called the forwarding information database). The charging functional block 13 comprises the charging logic.

FIG. 2 schematically illustrates the case that an initiating subscriber A sends a multimedia message to a first (destination) subscriber B. This is done by means of using the International Mobile Subscriber Identity (IMSI) of the first subscriber in order to address the multimedia message to the first subscriber. The International Mobile Subscriber Identity (IMSI) of the first subscriber B is hereinafter also called the first International Mobile Subscriber Identity (IMSI). The representation of the inventive method as shown in FIG. 2 supposes that a multimedia message forwarding is requested by the first subscriber B or that a multimedia message forwarding is requested for multimedia messages (at least at the moment of the reception of an multimedia message) directed to the first International Mobile Subscriber Identity (IMSI). It is assumed (according to FIG. 2) that the requested forwarding of multimedia messages directed to the first International Mobile Subscriber Identity (IMSI) (of the first subscriber B) is provided such that a forwarding to a second subscriber C is requested, the second subscriber C having also a International Mobile Subscriber Identity (IMSI), hereinafter also called second International Mobile Subscriber Identity (IMSI).

According to the present invention, an incoming multimedia message is addressed to the first International Mobile Subscriber Identity (IMSI) and is forwarded to the second International Mobile Subscriber Identity (IMSI). This is done by means of the unit 10 providing a multimedia message forwarding function. The unit 10 providing a multimedia message forwarding function modifies the manner of signalling to the first subscriber B that an incoming multimedia message has arrived. This is done by means of influencing the message and signalization exchange (via the MM1 interface) between the Multimedia Messaging Service Center (MMSC) or the Wireless Application Part Gateway (WAP GW) on the other hand and the first subscriber B on the other hand.

According to an embodiment of the present invention, a plurality of different possibilities exist for providing the information to the Core Network 20 that a forwarding to the second International Mobile Subscriber Identity (IMSI) (or second subscriber) is required for an incoming multimedia message directed to the first International Mobile Subscriber Identity (IMSI) (or first subscriber). According to one embodiment of such a provisioning (or definition) of a forwarding request, the corresponding information (usually comprising or being assigned to the first International Mobile Subscriber Identity (IMSI), and further comprising or being assigned to the second International Mobile Subscriber Identity (IMSI)) can be stored in the forwarding information database as a part of the unit 10 providing a multimedia message forwarding function, such a forwarding information database being preferably associated with the translation functional block. According to one embodiment of such a provisioning (or definition) of a forwarding request, the corresponding information can be stored in a forwarding information database external to the unit 10 providing a multimedia message forwarding function or in a forwarding information database only assigned or associated to the unit 10 providing a multimedia message forwarding function.

Different forwarding scenarios are possible according to the present invention, e.g. depending on the time of reception of the multimedia message, the state of activation of the subscriber related to the first International Mobile Subscriber Identity (IMSI), and/or the state of activation of the subscriber related to the second International Mobile Subscriber Identity (IMSI). An unconditional forwarding is also possible according to an embodiment of the present invention.

In case of a defined forwarding address and a valid forwarding condition, the communication between the Multimedia Messaging Service Center (MMSC) and the addressed first subscriber is changed by means of the unit 10 providing a multimedia message forwarding function. Especially, messages of the Mobile Application Part (MAP) are relevant in this respect, namely:
SendRoutingInformationForShortMessage (SRIforSM),
ReportShortMessageDeliveryStatus (RepSmDs), and
AlertServiceCenter (AlertSc).

In these messages, the destination address (such as the International Mobile Subscriber Identity (IMSI) or other identity information) is changed by the unit 10 providing a multimedia message forwarding function in the communication between the Multimedia Messaging Service Center (MMSC) or the Wireless Application Part Gateway (WAP GW) on the one hand and the subscriber database (such as the Home Location Register (HLR)) according the forwarding request or forwarding information in order to provide a delivery of the message to the second subscriber C (or second International Mobile Subscriber Identity (IMSI)).

The interaction functional block 11 is responsible for the communication to entities of the Core Network 20 that are external to the unit 10 providing a multimedia message forwarding function. This communication includes the communication regarding the event of an incoming multimedia message (i.e. the signalisation via the MM1 interface during the signalisation of an incoming multimedia message to the first and/or second subscriber B, C) as well as the provisioning of the corresponding forwarding rules, forwarding information, and forwarding address (i.e. the address of the second subscriber or second International Mobile Subscriber Identity (IMSI)). The provisioning can be provided via different channels such as Unstructured Supplementary Service Data (USSD), a graphical user interface in an internet application (WEB-UI) or a Dual Tone Multiple Frequency menu (DTMF-menu). The interaction functional block 11 needs to support these provisioning channels.

The charging functional block 13 is responsible for a charging of the events and services used during the utilisation of the multimedia message forwarding functionality according to an embodiment of the present invention. It is possible according to the present invention to charge the use of the multimedia message forwarding functionality based on regular payments (e.g. a monthly option fee) or by means of a fee dependent on the event of actual use of the multimedia message forwarding functionality. This usually depends on the strategy implemented by the operator of the Core Network 20. Thereby, it is possible to change the use of the forwarding functionality by means of charging tickets (intended to be included in the charging process of the operator of the Core Network 20) or by means of an online charging (e.g. via a Camel application such as CAPv3 (CAMEL Application Part), e.g. for prepaid subscribers.

An advantage of an embodiment of the present invention is based on the fact that due to the integration of the unit 10 providing a multimedia message forwarding function between the Multimedia Messaging Service Center (MMSC) or the Wireless Application Part Gateway (WAP GW) on the one hand and the subscriber database (such as the Home Location Register (HLR)) on the other hand, it is possible to realise the inventive method without a modification of interfaces, protocols and service logics. Only a configuration of the Multimedia Messaging Service Center (MMSC) and/or the Wireless Application Part Gateway (WAP GW) is required in this embodiment, such that the provisioned forwarding request information (or forwarding information) are taken into consideration. If such provisioned forwarding request information are stored in the forwarding information database of the unit 10 providing a multimedia message forwarding function, then the multimedia message can be correctly routed to the second subscriber C or second International Mobile Subscriber Identity (IMSI).

According to an embodiment of the present invention, the interaction functional block 11 of the unit 10 unit providing a multimedia message forwarding function comprise the following functions:
provisioning 111,
charging 112,
statistics 113, as well as
content/messaging 114.

According to an embodiment of the present invention, the translation functional block 12 of the unit 10 unit providing a multimedia message forwarding function comprise the following functions:
provisioning 121,
external provisioning 122,
internal charging 123
modification of subscriber data 124
statistics 125, as well as
service handling 126.

According to t an embodiment of the present invention, the charging functional block 13 of the unit 10 unit providing a multimedia message forwarding function comprise the following functions:
internal charging 131,
external charging 132, as well as
event handling 133.

While the invention has been described with reference to particular embodiments thereof, it will be understood by those having ordinary skill the art that various changes may be made therein without departing from the scope and spirit of the invention. Further, the present invention is not limited to the embodiments described herein; reference should be had to the appended claims.

1-21. (canceled)

22. A method for forwarding multimedia messages in a public land mobile network using a core network with a unit providing a multimedia message forwarding function, the method comprising:
storing, in a forwarding information database, a multimedia message forwarding information related to forwarding, to a second international mobile subscriber identity, of multimedia messages directed to a first international mobile subscriber identity;
receiving, at the public land mobile network, a request for a delivery of a mobile terminated multimedia message to the first international mobile subscriber identity;
determining, by the multimedia message forwarding function, the multimedia message forwarding information; and
forwarding, by the multimedia message forwarding function, the multimedia message to the second international mobile subscriber identity based on the multimedia message forwarding information so that the forwarding is performed based on at least one of a time of reception of the multimedia message, a state of activation of a subscriber associated with the first international mobile subscriber identity and a state of activation of the subscriber associated with the second international mobile subscriber identity.

23. The method according to claim 22, wherein the multimedia message forwarding information includes, and the forwarding is based on, at least one of a location information of the subscriber associated with the first international mobile subscriber identity and a location information of the subscriber associated with the second international mobile subscriber identity.

24. The method according to claim 23, wherein the multimedia message forwarding information is defined by at least one of an unstructured supplementary service data message, an interne user interface, and a dual tone multiple frequency menu.

25. The method according to claim 23, further comprising at least one of initializing and defining a charge for the forwarding of the multimedia message by the multimedia message forwarding function.

26. The method according to claim 25, wherein the multimedia message forwarding information is defined by at least one of an unstructured supplementary service data message, an internet user interface, and a dual tone multiple frequency menu.

27. The method according to claim 22, wherein the multimedia message forwarding information is defined by at least one of an unstructured supplementary service data message, an internet user interface, and a dual tone multiple frequency menu.

28. The method according to claim 22, further comprising at least one of initializing and defining a charge for the forwarding of the multimedia message by the multimedia message forwarding function.

29. The method according to claim 28, wherein the multimedia message forwarding information is defined by at least one of an unstructured supplementary service data message, an interne user interface, and a dual tone multiple frequency menu.

30. A core network for forwarding multimedia messages in a public land mobile network comprising:
at least one of a multimedia messaging service center and a wireless application part gateway;
a forwarding information database; and
a forwarding function unit configured to provide a multimedia message forwarding function to forward, to a second international mobile subscriber identity based on a multimedia message forwarding information stored in the forwarding information database, a multimedia message directed to a first international mobile subscriber identity.

31. The core network according to claim 30, wherein the multimedia message forwarding information includes, and the forwarding is based on, at least one of a time of reception of the multimedia message, a state of activation of a subscriber associated with the first international mobile subscriber identity and a state of activation of the subscriber associated with the second international mobile subscriber identity.

32. A unit configured to provide a multimedia message forwarding function in a core network, wherein the multimedia message forwarding function is configured to forward, to a second international mobile subscriber identity based on a multimedia message forwarding information stored in a forwarding information database of the core network, a multimedia message which is directed to a first international mobile subscriber identity.

33. The unit according to claim 32, wherein the multimedia message forwarding information includes, and the forwarding is based on, at least one of a time of reception of the multimedia message, a state of activation of a subscriber associated with the first international mobile subscriber identity and a state of activation of the subscriber associated with the second international mobile subscriber identity.

34. A computer program product comprising a non-transitory computer-readable storage medium having computer-readable program instructions configured, when running on a processor, to execute the following steps:
storing, in a forwarding information database, a multimedia message forwarding information related to forwarding, to a second international mobile subscriber identity, of multimedia messages directed to a first international mobile subscriber identity;
receiving, at the public land mobile network, a request for a delivery of a mobile terminated multimedia message to the first international mobile subscriber identity;
determining, by the multimedia message forwarding function, the multimedia message forwarding information; and
forwarding, by the multimedia message forwarding function, the multimedia message to the second international mobile subscriber identity based on the multimedia message forwarding information so that the forwarding is performed based on at least one of a time of reception of the multimedia message, a state of activation of a subscriber associated with the first international mobile subscriber identity and a state of activation of the subscriber associated with the second international mobile subscriber identity.

35. The computer program product according to claim 34, wherein the multimedia message forwarding information includes, and the forwarding is based on, at least one of a location information of the subscriber associated with the first international mobile subscriber identity and a location information of the subscriber associated with the second international mobile subscriber identity.

36. The computer program product according to claim 35, further comprising at least one of initializing and defining a charge for the forwarding of the multimedia message by the multimedia message forwarding function.

37. The computer program product according to claim 34, further comprising at least one of initializing and defining a charge for the forwarding of the multimedia message by the multimedia message forwarding function.

38. The computer program product according to claim 34, wherein the multimedia message forwarding information is defined by at least one of an unstructured supplementary service data message, an Internet user interface, and a dual tone multiple frequency menu.

39. A computer program product comprising a non-transitory computer-readable storage medium having computer-readable program instructions configured to control a core network according to claim 30.

40. The computer program product according to claim 39, wherein the multimedia message forwarding information includes, and the forwarding is based on, at least one of a time of reception of the multimedia message, a state of activation of a subscriber associated with the first international mobile subscriber identity and a state of activation of the subscriber associated with the second international mobile subscriber identity.

41. A computer program product comprising a non-transitory computer-readable storage medium having computer-readable program instructions configured to control a unit of a core network according to claim 32.

42. The computer program product according to claim 41, wherein the multimedia message forwarding information includes, and the forwarding is based on, at least one of a time of reception of the multimedia message, a state of activation of a subscriber associated with the first international mobile subscriber identity and a state of activation of the subscriber associated with the second international mobile subscriber identity.
